(19) United States
(12) Patent Application Publication
(10) Pub. No.: US 2011/0147170 A1
(43) Pub. Date: Jun. 23, 2011

(54) SECURE LOCKING MECHANISM FOR PUSHBUTTON CONTROL BOX

(76) Inventors: Li-Fen LIAO, Taichung City (TW); Tai-Hung Lin, Taichung City (TW)

(21) Appl. No.: 12/641,726

(22) Filed: Dec. 18, 2009

(51) Int. Cl. H01H 9/20

(52) U.S. Cl. 200/43.13

(57) ABSTRACT

A secure locking mechanism for pushbutton control box, including a box body and a locking mechanism. The locking mechanism includes several secure locking switches and multiple rotary buttons. The secure locking switches are arranged on a controlling circuit board and serially connected with corresponding control switches disposed thereon. The secure locking switches are movable between an ON position and an OFF position to control electronic signal transmission of the control switches. Each rotary button has a locking body eccentrically disposed on an end face of the rotary button for controlling making/breaking of the secure locking switch. An operator can operate the rotary buttons from outer side of the box body to ensure security. By means of varying the type of serial connection, each secure locking switch can flexibly control electronic signal transmission of one single control switch or plural or even all control switches of the pushbutton control box.

### BACKGROUND OF THE INVENTION

The present invention relates generally to a secure system for an operation interface, and more particularly to a secure locking mechanism for pushbutton control box.

It is known that a pushbutton control box is often used to control industrial or medical appliances or implements. The pushbutton control box collectively has multiple pushbuttons for an operator to wiredly or remotely control the operation of the appliances or implements.

In order to avoid false operation of the appliances or implements due to mistouch of the pushbutton control box so as to ensure safety, a security mechanism 1 for pushbutton control box has been developed as shown in FIGS. 1 and 2. The security mechanism 1 includes a butterfly-shaped secure plate 2 pivotally disposed in the box body of the pushbutton control box. The secure plate 2 has two wing sections formed with two perforations 3 respectively. Each perforation 3 has a narrowed section. The button heads 4 of two pushbuttons 5 corresponding to tactile switches 5 are fitted in the perforations 3 respectively. The secure plate 2 can be rotated to make the button heads 4 enter the narrowed sections of the perforations 3. Under such circumstance, the secure plate 2 can resist against the depression force and prevent the pushbuttons 5 from moving downward. Accordingly, false operation caused by mistouch of the pushbutton control box can be avoided so as to ensure safety.

The above security mechanism is able to achieve security effect to a certain extent. However, such arrangement is not optimal and has some defects. First, the butterfly-shaped secure plate 2 is operated by way of rotation. In this case, the butterfly-shaped secure plate 2 will always synchronously control two button heads 4 positioned in the perforations 3. The number of the tactile switches controllable by one single butterfly-shaped secure plate cannot be freely increased or decreased in accordance with specific security requirement. Therefore, the flexibility of practical application of such security mechanism is low. Second, the butterfly-shaped secure plate 2 is positioned between the laminated circuit board 6 and the pushbuttons 5 to prevent the pushbuttons 5 from being depressed so as to avoid false operation. However, such security mechanism can achieve security effect only in normal state. In the case of a great external force, the pushbuttons 5 will be still depressed to cause false operation. Third, the butterfly-shaped secure plate 2 always synchronously controls two tactile switches and needs to be positioned between the laminated circuit board 6 and the pushbuttons 5 for avoiding false operation. It is troublesome and uneconomic to assemble the components of the conventional security mechanism.

### SUMMARY OF THE INVENTION

It is therefore a primary object of the present invention to provide a secure locking mechanism for pushbutton control box, which is easy to assemble and is manufactured at lower cost. In addition, the secure locking mechanism has smaller volume and simpler structure.

To achieve the above and other objects, the secure locking mechanism for pushbutton control box of the present invention includes: a box having a box body for accommodating a controlling circuit board therein, at least one control switch being arranged on the controlling circuit board and movable between an ON position and an OFF position to control making/breaking of corresponding circuits of the controlling circuit board, at least one pushbutton being arranged on the box body corresponding to the control switch for an operator to control making/breaking of the control switch via the pushbutton; and a locking mechanism for controlling the control switches to control making/breaking of the circuits of the controlling circuit board. The secure locking mechanism is characterized in that the locking mechanism includes at least one secure locking switch arranged in the box body and serially connected with the control switch. The secure locking switch is movable between an ON position and an OFF position. The locking mechanism further includes at least one column-shaped rotary button rotatably disposed on the box body. The rotary button has a locking body eccentrically disposed at one end of the rotary button and protruding therefrom. The locking body is movable between a locking position and an unlocking position along with the rotation of the rotary button. When positioned in the locking position, the locking body breaks the circuit of the secure locking switch to cut off the transmission of electronic signals from the control switch to the controlling circuit board. When positioned in the unlocking position, the locking body makes the circuit of the secure locking switch to allow the transmission of electronic signals from the control switch to the controlling circuit board.

The present invention can be best understood through the following description and accompanying drawings, wherein:

### BRIEF DESCRIPTION OF THE DRAWINGS

FIG. 1 is a perspective view of a conventional security mechanism;

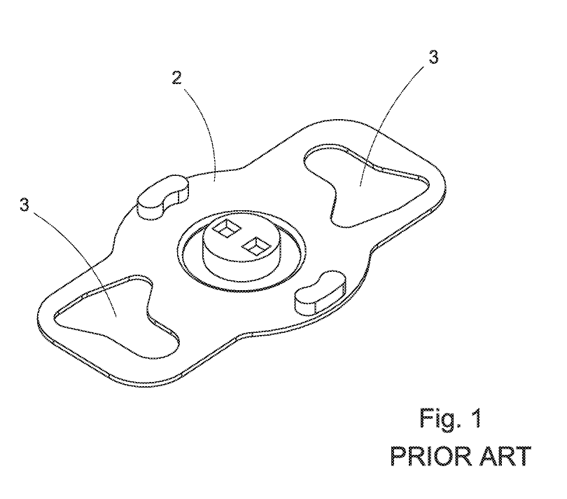

FIG. 2 is a plane view of the conventional security mechanism;

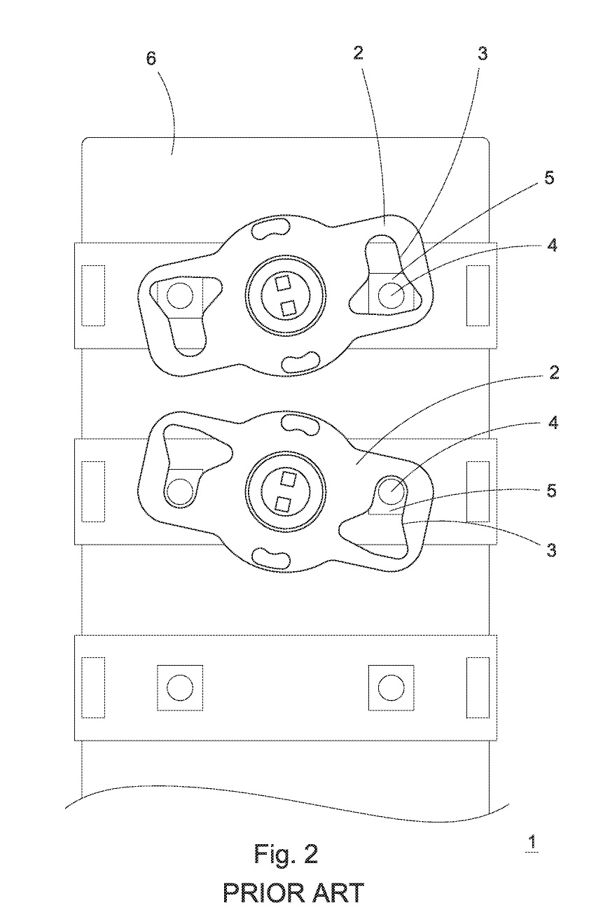

FIG. 3 is a perspective view of the rotary button of a preferred embodiment of the secure locking mechanism of the present invention;

FIG. 4 is a perspective exploded view of the preferred embodiment of the secure locking mechanism of the present invention;

FIG. 5 is a perspective assembled view of the preferred embodiment of the secure locking mechanism of the present invention;

FIG. 6 is a circuit diagram showing the serial connection between the secure locking switches and the control switches of the present invention;

FIG. 7 is a sectional view taken along line a-a of FIG. 5;

FIG. 8 is a sectional view taken along line b-b of FIG. 5; and

FIG. 9 is a sectional view showing the operation of the preferred embodiment of the secure locking mechanism of the present invention.

### DETAILED DESCRIPTION OF THE PREFERRED EMBODIMENT

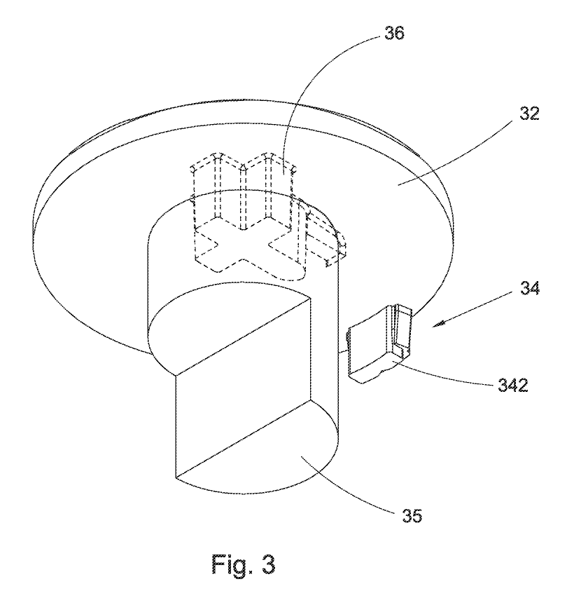

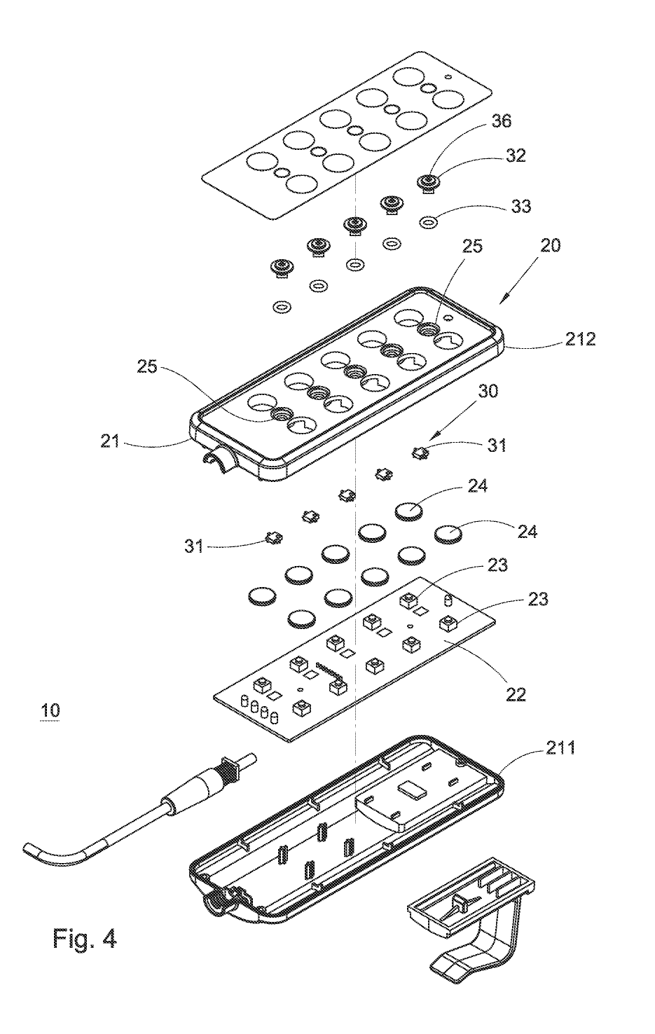

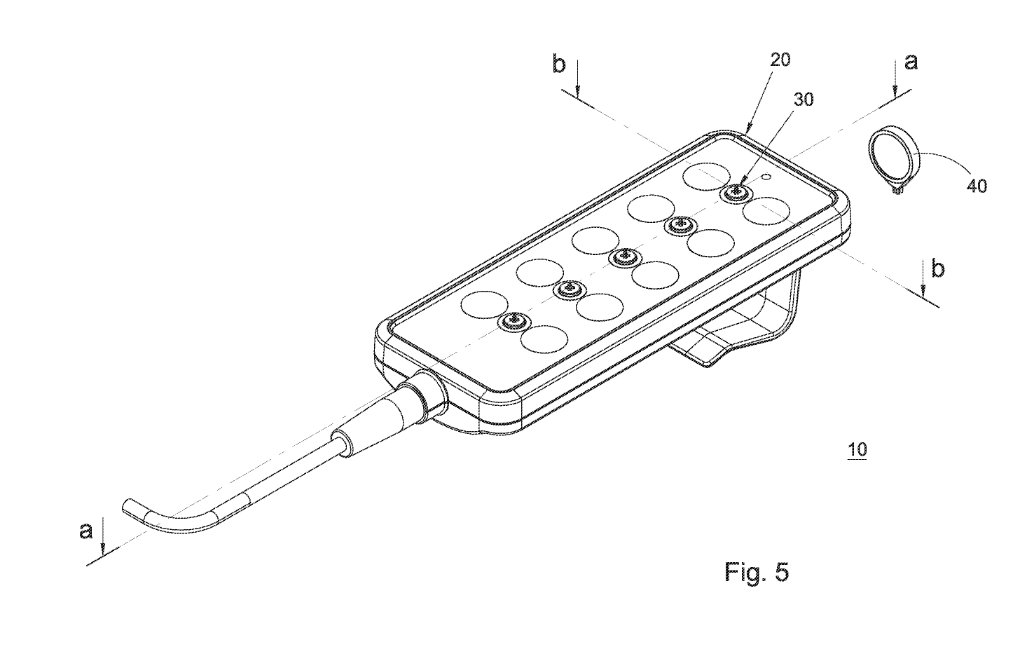

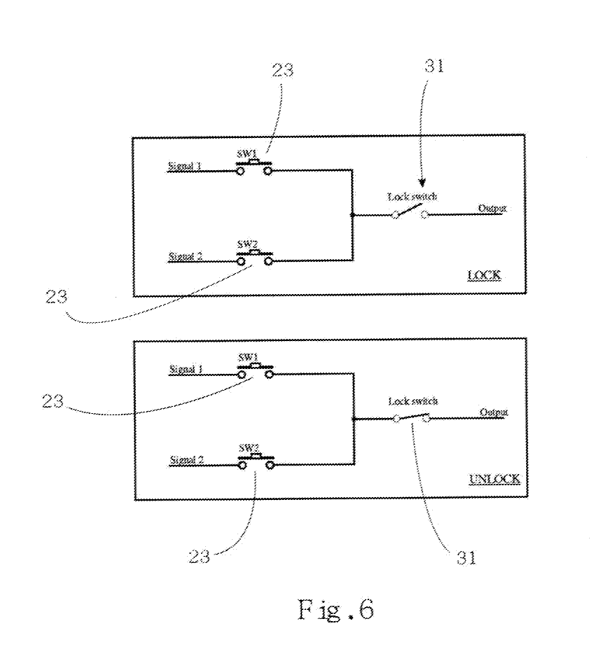

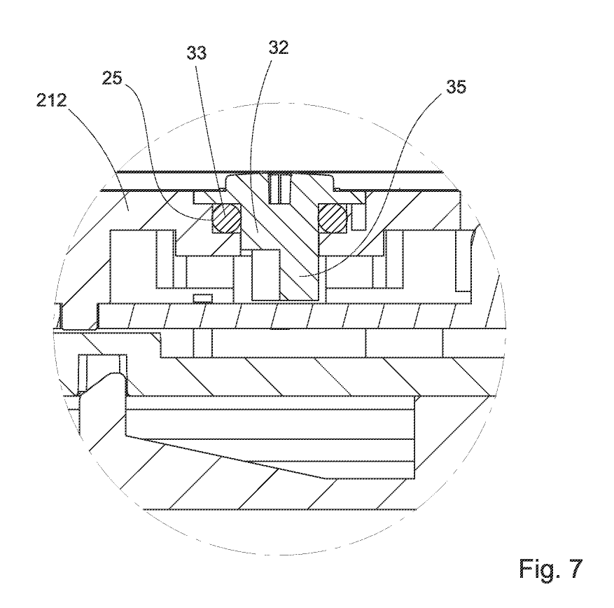

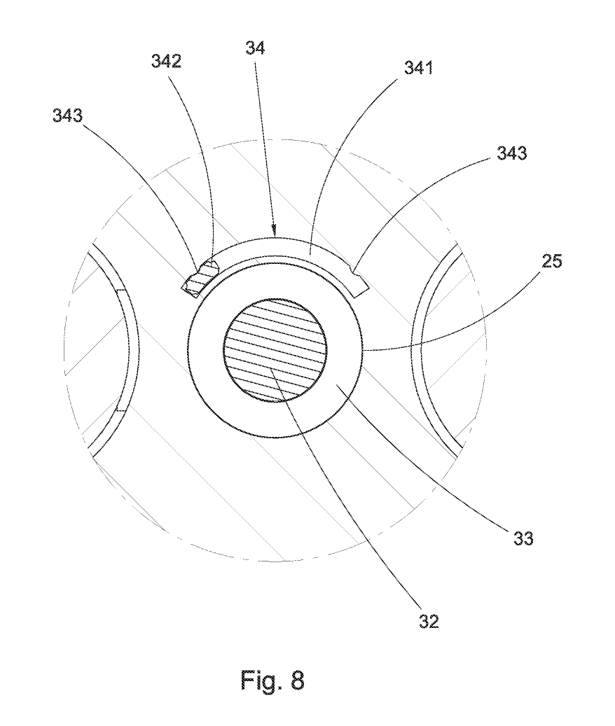

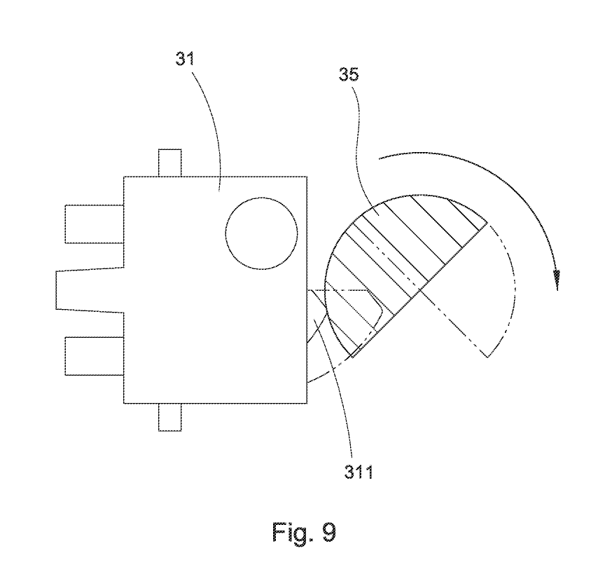

Please refer to FIGS. 3 to 9. According to a preferred embodiment, the secure locking mechanism 10 for pushbutton control box of the present invention includes a box 20 and a locking mechanism 30.

The box 20 has a rectangular hollow box body 21 composed of a bottom casing 211 and an upper cover 212 mated therewith. A controlling laminated circuit board 22 is fixedly disposed in the box body 21. Multiple control switches 23 are arranged on the controlling circuit board 22 and movable between an ON position and an OFF position to control making/breaking of the corresponding circuits of the controlling circuit board 22. Several pushbuttons 24 are arranged on the box body 21 for an operator to control the corresponding control switches 23 via the pushbuttons 24 from outer side of the pushbutton control box. The control switches 23 and the pushbuttons 24 are sequentially arranged side by side in pairs along the length of the box body 21. The controlling technique related to the control switches, such as tactile switches, pertains to prior art and is not the subject of the present invention. Therefore, the relevant controlling technique of the control switches will not be further described hereinafter. The box body 21 has multiple buttonholes 25 formed through the upper cover 212 between the pairs of pushbuttons 24 respectively.

The locking mechanism 30 includes several secure locking switches 31 such as microswitches. The secure locking switches 31 are arranged on the controlling circuit board 22 and serially connected with the corresponding control switches 23. The secure locking switches 31 are back and forth displaceable between an ON position and an OFF position. When positioned in the OFF position, the internal circuit of the secure locking switch 31 is broken to cut off the transmission of electronic signals from the corresponding control switch 23 to outer side. When positioned in the ON position, the internal circuit of the secure locking switch 31 is made to continue the transmission of electronic signals from the corresponding control switch 23 to outer side. The locking mechanism 30 further includes multiple column-shaped rotary buttons 32 each having a first end and a second end. The first ends of the rotary buttons 32 are coaxially rotatably disposed in the corresponding buttonholes 25, whereby the rotary buttons 32 are rotatable between a locking position and an unlocking position. Multiple locating members 33, which are flexible O-rings, are coaxially fitted around the bodies of the rotary buttons 32 respectively. The rotary buttons 32 with the locating members 33 are then plugged into the buttonholes 25. Under such circumstance, the locating members 33 are radially compressed to exert a resilient force onto the walls of the buttonholes 25, whereby the circumferences of the locating members 33 tightly abut against the walls of the buttonholes 25 to locate the rotary buttons 32 therein. In this case, the rotary buttons 32 are prevented from being axially extracted out of the buttonholes 25. Each rotary button 32 has a restriction section 34 for restricting the rotary button 32 to rotate within the range between the locking position and the unlocking position and for locating the rotary button 32 in the locking position or the unlocking position. Each rotary button 32 further has a locking body 35 eccentrically disposed on an end face of the first end of the rotary button 32 and protruding from the end face in adjacency to a secure locking switch 31. When the rotary button 32 is positioned in the locking position, the locking body 35 abuts against a transmission shaft 311 of the adjacent secure locking switch 31, whereby the secure locking switch 31 is kept in the OFF position and the internal circuit of the secure locking switch 31 is broken. On the other hand, when the rotary button 32 is positioned in the unlocking position, the locking body 35 releases the transmission shaft 311 of the secure locking switch 31, whereby the internal circuit of the secure locking switch 31 is made again. Multiple slot-shaped turning sections 36 are formed on an end face of the second end of the rotary button 32. An operator can insert an external insertion piece 40 into the turning sections 36 as an operation interface to turn the rotary button 32 between the locking position and the unlocking position.

The restriction section 34 has an arc-shaped restriction slot 341 with a certain arc length. The arc-shaped restriction slot 341 is formed on the upper cover 212 in adjacency to a buttonhole 25. The curvature center of the arc-shaped restriction slot 341 coincides with the axis of the buttonhole 25. The restriction section 34 further has a bar-shaped restriction body 342. A first end of the restriction body 342 is fixedly connected with the rotary button 32, while a second end of the restriction body 342 is inserted in the arc-shaped restriction slot 341 for restricting the rotary button 32 to rotate within an angle range. Two protrusions 343 are disposed at two ends of the arc-shaped restriction slot 341 for engaging with the restriction body 342 to locate the rotary button 32.

According to the above arrangement, the secure locking mechanism 10 for the pushbutton control box of the present invention is able to lock the corresponding control switches in a circuit manner. In comparison with the conventional mechanical locking mechanism, the present invention has the following advantages:
1. The locking and unlocking operation can be precisely performed in the circuit manner. In contrast, the conventional mechanical locking mechanism may fail to provide locking effect due to mechanical error or too great external force.
2. The serial connection form between the secure locking switches 31 and the control switches 23 can be varied to change the number of the control switches 23 controllable by one single secure locking switch 31. That is, one single secure locking switch can be used to control one single control switch or all the control switches. Therefore, the application of the secure locking mechanism can be more flexibly used.
3. In assembling process of the secure locking mechanism 30, after the box 20 is assembled, an operator only needs to fit the locating member 33 onto the rotary button 32 and then directly plug the rotary button 32 into the buttonhole 25 from outer side of the box 20. In comparison with the conventional locking mechanism, the secure locking mechanism of the present invention is easy to assemble and is manufactured at lower cost. In addition, the secure locking mechanism of the present invention has smaller volume and simpler structure.

The above embodiment is only used to illustrate the present invention, not intended to limit the scope thereof. Many modifications of the above embodiment can be made without departing from the spirit of the present invention.

What is claimed is:

1. A secure locking mechanism for pushbutton control box, comprising:
a box having a box body for accommodating a controlling circuit board therein, at least one control switch being arranged on the controlling circuit board and movable between an ON position and an OFF position to control making/breaking of corresponding circuits of the controlling circuit board, at least one pushbutton being arranged on the box body corresponding to the control switch for an operator to control making/breaking of the control switch via the pushbutton; and
a locking mechanism for controlling the control switches to control making/breaking of the circuits of the controlling circuit board, the secure locking mechanism being characterized in that the locking mechanism includes at least one secure locking switch arranged in the box body and serially connected with the control switch, the secure locking switch being movable between an ON position and an OFF position, the locking mechanism further including at least one column-shaped rotary button rotatably disposed on the box body, the rotary button having a locking body eccentrically disposed at one end of the rotary button and protruding therefrom, the locking body being movable between a locking position and an unlocking position along with the rotation of the rotary button, whereby when positioned in the locking position, the locking body breaks the circuit of the secure locking switch to cut off the transmission of electronic signals from the control switch to the controlling circuit board, while when positioned in the unlocking position, the locking body makes the circuit of the secure locking switch to allow the transmission of electronic signals from the control switch to the controlling circuit board.

2. The secure locking mechanism for pushbutton control box as claimed in claim 1, wherein the box body has at least one buttonhole formed on one face of the box body, the rotary button being coaxially rotatably fitted in the buttonhole, the locking mechanism further including at least one restriction section for restricting the rotary button to rotate within the range between the locking position and the unlocking position, the restriction section having an arc-shaped restriction slot with a predetermined arc length and a restriction body slidably inserted in the arc-shaped restriction slot, the arc-shaped restriction slot having a curvature center coinciding with that of the buttonhole.

3. The secure locking mechanism for pushbutton control box as claimed in claim 2, wherein the locking mechanism further includes at least one locating member positioned between a wall of the buttonhole and the rotary button for preventing the rotary button from axially displacing.

4. The secure locking mechanism for pushbutton control box as claimed in claim 3, wherein the locating member is a flexible O-ring coaxially fitted around the body of the rotary button, whereby a circumference of the locating member tightly abuts against the wall of the buttonhole.
